(19) United States
(12) Patent Application Publication
(10) Pub. No.: US 2009/0036068 A1
(43) Pub. Date: Feb. 5, 2009

(54) WIRELESS SYSTEM HAVING HIGH SPECTRAL PURITY

(75) Inventors: Simon HUGHES, Waterloo (CA); Jason JANTZI, Kitchener (CA); Xavier ULDRY, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: SIRIFIC WIRELESS CORPORATION, Waterloo (CA)

(21) Appl. No.: 11/832,960

(22) Filed: Aug. 2, 2007

(51) Int. Cl. H04B 1/04

(52) U.S. Cl. 455/114.1

(57) ABSTRACT

A wireless system having high spectral purity output signals. The wireless system has a transmitter circuit for transmitting an output signal and a power amplifier for amplifying the output signal for wireless transmission via an antenna. Positioned in-line with the output signal between the transmitter circuit and the power amplifier is a harmonic trap configured for inhibiting harmonics within a predetermined frequency range generated by the power amplifier from leaking into the transmitter circuit. The harmonic trap can be implemented as a discrete device, or integrated within the transmitter circuit or integrated within the power amplifier. By inhibiting the harmonics from leaking into the transmitter circuit, degraded performance of the transmitter circuit is prevented.

### FIELD OF THE INVENTION

The present invention relates generally to wireless communication. More particularly, the present invention relates to wireless devices having transmit functionality.

### BACKGROUND OF THE INVENTION

Wireless devices have been in use for many years for enabling mobile communication of voice and data. Such devices can include mobile phones and wireless enabled personal digital assistants (PDA's) for example. FIG. 1 is a generic block diagram of the core components of such wireless devices. The wireless core 10 includes a baseband processor 12 for controlling application specific functions of the wireless device and for providing and receiving voice or data signals to a radio frequency (RF) transceiver chip 14. The RF transceiver chip 14 is responsible for frequency up-conversion of transmission signals, and frequency down-conversion of received signals. RF transceiver chip 14 includes a receiver core 16 connected to an antenna 18 for receiving transmitted signals from a base station or another mobile device, and a transmitter core 20 for transmitting signals through the antenna 18. Those of skill in the art should understand that FIG. 1 is a simplified block diagram, and can include other functional blocks that may be necessary to enable proper operation or functionality. For example, wireless device 10 will have a power amplifier for amplifying signals from the transmitter core 20, and a low noise amplifier for amplifying the signals received via the antenna 18.

Generally, the transmitter core 20 is responsible for up-converting electromagnetic signals from baseband to higher frequencies for transmission, while receiver core 16 is responsible for down-converting those high frequencies back to their original frequency band when they reach the receiver, processes known as up-conversion and down-conversion respectively. The original (or baseband) signal may be, for example, data, voice or video. These baseband signals may be produced by transducers such as microphones or video cameras, be computer generated, or transferred from an electronic storage device. In general, the high frequencies provide longer range and higher capacity channels than baseband signals, and because high frequency radio frequency (RF) signals can propagate through the air, they are preferably used for wireless transmissions as well as hard-wired or fibre channels.

All of these signals are generally referred to as radio frequency (RF) signals, which are electromagnetic signals; that is, waveforms with electrical and magnetic properties within the electromagnetic spectrum normally associated with radio wave propagation.

FIG. 2 is a schematic showing further details of the transmitter core and its output path to the antenna 18. The transmit path includes the transmitter core 20, a power amplifier 22 and antenna 18. Transmitter core 20 includes a voltage controlled oscillator (VCO) 30, a divide-by-N circuit 32, a mixer 34 and a pre-driver/amplifier 36. Generally, the VCO 30 is set to provide an oscillating frequency signal that is a multiple of the output frequency provided by driver/amplifier 36. For example, if the output frequency of driver/amplifier 36 is f_{T}, then the VCO can run at 4 f_{T}. Divide-by-N circuit receives the VCO signal and divides it by N, in this example N=4, to feed the mixer 34. Mixer 34 combines the data signal BBout from the baseband processor to generate the output signal at f_{T}, which is then provided to the power amplifier 22 for transmission via antenna 18.

The RF transceiver 14, and in particular the exemplary configuration of VCO 30, divide-by-N circuit 32, and mixer 34 of transmitter core 20 is known as a direct conversion architecture. The direct conversion architecture is versatile for generating narrowband signals for a plurality of standards, one being the GSM/GMSK standard for example. It is versatile because the same circuit can be used for different narrow band standards, thereby greatly simplifying multi-mode RF transceivers. Of course, each standard has specifications, such as transmit specifications, which must be met or exceeded by the mobile device. One specification for the GSM standard is the amount of allowable noise in adjacent and second adjacent channels, generated by the wireless device during a transmit operation. Unfortunately, an issue with direct conversion transmitter core architectures is its susceptibility to harmonics perturbations affecting VCO phase noise.

Through testing, it has been discovered that due to its non-linear characteristics, power amplifier 22 will generate harmonics in response to the output signal at f_{T}. In particular, one of the harmonics will be situated at 4 f_{T} (nf_{T}), and will leak back into the transmitter core 14 and VCO 30, as illustrated through leakage path 38. This harmonic interference will leak into VCO 30 and degrade the phase noise of VCO 30, which in turn degrades the downstream generation of the output signal provided to the power amplifier 22. This performance degradation is illustrated in the graphical plot of noise (dB) vs frequency (f) in FIG. 3.

In FIG. 3, an ideal output response from the power amplifier 22 is plotted as curve 50. The desired signal at f_{T} should have high power or low loss, however the side bands should have minimized power. Some wireless standards may require that the maximum power of signals positioned below f_{T}−Δf and above f_{T}+Δf must not exceed Max_dB. The actual specifications for Δf and Max_dB can vary depending on the standard being used. In one example, Max_dB is −60 dB and Δf is 400 kHz. However, due to the leakage of harmonic noise from the power amplifier 22 back into the VCO 30, the spectral purity of the signal is degraded, resulting in the degraded output response of curve 52. Now the power at f_{T}−Δf and at f_{T}+Δf, where Δf is the modulation frequency offset, will be at a level that is greater than Max_dB. If the transceiver does not provide sufficient margin to account for this degradation, the device will fail to meet the required specification. The harmonics generated by the power amplifier are not limited to 4 f_{T}, but can be at any frequency nf_{T}, where n is the order of harmonic, depending on the direct conversion architecture of the transmitter core.

While there may be other sources of spectral degradation, they may be overshadowed by the degradation caused by the generation of harmonics by the power amplifier 22. It is, therefore, desirable to provide a wireless device that is immune to the harmonics generated by a power amplifier, to maintain spectral purity of the output signal.

### SUMMARY OF THE INVENTION

It is an object of the present invention to obviate or mitigate at least one disadvantage of previous power supply rejection circuits.

In a first aspect, the present invention provides a wireless device. The wireless device includes a transmit circuit, a power amplifier and a harmonic trap. The transmit circuit provides an output signal at a transmit frequency. The power amplifier receives the output signal and provides an amplified output signal, such that the power amplifier generates harmonics at a specific frequency. The harmonic trap passes the output signal having the transmit frequency and inhibits the harmonics from passing into the transmit circuit.

According to embodiments of the present aspect,the specific frequency is an integer multiple of the transmit frequency, the harmonic trap can be a discrete device positioned in a path of the output signal between the transmit circuit and the power amplifier, or the harmonic trap can be integrated with the transmit circuit or the power amplifier.

In a further embodiment of the present aspect, the harmonic trap is a passive circuit which includes a capacitor configured to have a frequency response effective for attenuating the harmonics at the specific frequency. Alternately, the passive circuit includes a set of capacitors selectively enabled in parallel with each other to have a frequency response effective for attenuating the harmonics at the specific frequency. Alternately, the harmonic trap is an active circuit. In yet another embodiment, the transmit circuit and the power amplifier are soldered to a printed circuit board, and the harmonic trap is integrated in the printed circuit board as distributed transmission lines.

In a second aspect, the present invention provides a radio frequency transceiver for providing an output signal to a power amplifier. The radio frequency transceiver includes a transmitter core and a harmonic trap. The transmitter core generates the output signal at a transmit frequency. The harmonic trap passes the output signal having the transmit frequency, and inhibits harmonics at a specific frequency from entering the transmitter core, where the harmonics are generated by the power amplifier. According to embodiments of the present aspect, the specific frequency is an integer multiple of the transmit frequency, and the harmonic trap is either a passive circuit or an active circuit.

In a third aspect, the present invention provides a power amplifier for providing an amplified signal corresponding to an output signal received from a transmitter circuit. The power amplifier includes amplification circuitry and a harmonic trap. The amplification circuitry receives the output signal for generating the amplified signal, where the amplification circuitry generating harmonics at a specific frequency. The harmonic trap passes the output signal having a transmit frequency and inhibits the harmonics from passing to the transmitter circuit. In the present aspect, the specific frequency is an integer multiple of the transmit frequency.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of core components of a wireless device;

FIG. 2 is a schematic of a transmit path of a wireless device of the prior art;

FIG. 3 is a graphical plot of power vs frequency for the output signal generated by the transmit path of FIG. 2;

FIG. 4 is a schematic of a transmit path having a discrete harmonic trap, according to an embodiment of the present invention;

FIG. 5 is a response curve for the harmonic trap shown in FIG. 4;

FIG. 6 is a schematic of a transmit path having a harmonic trap integrated in a transmitter circuit, according to an embodiment of the present invention;

FIG. 7 is a schematic of a transmit path having a harmonic trap integrated in a power amplifier, according to an embodiment of the present invention;

FIG. 8 is a schematic of a harmonic trap, according to an embodiment of the present invention; and,

FIG. 9 is a schematic of a transmit path having a harmonic trap integrated in the PCB.

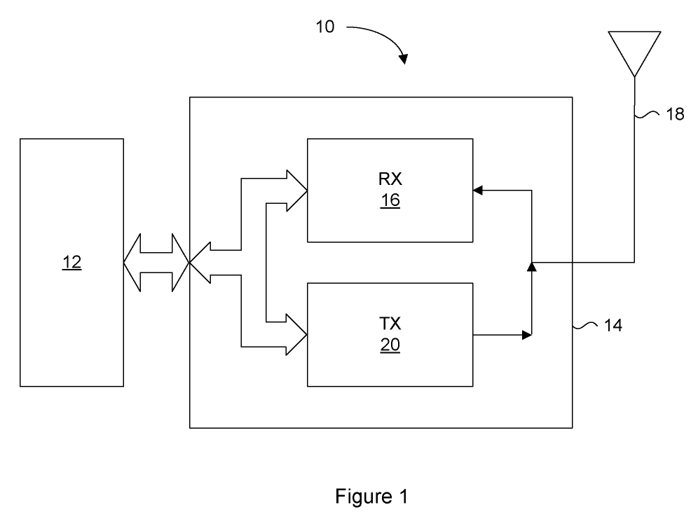

### DETAILED DESCRIPTION

Generally, the present invention provides a wireless system having high spectral purity output signals. The wireless system has a transmitter circuit for transmitting an output signal and a power amplifier for amplifying the output signal for wireless transmission via an antenna. Positioned in-line with the output signal between the transmitter circuit and the power amplifier is a harmonic trap configured for inhibiting harmonics within a predetermined frequency range generated by the power amplifier from leaking into the transmitter circuit. The harmonic trap can be implemented as a discrete device, or integrated within the transmitter circuit or integrated within the power amplifier. By inhibiting the harmonics from leaking into the transmitter circuit, degraded performance of the transmitter circuit is prevented.

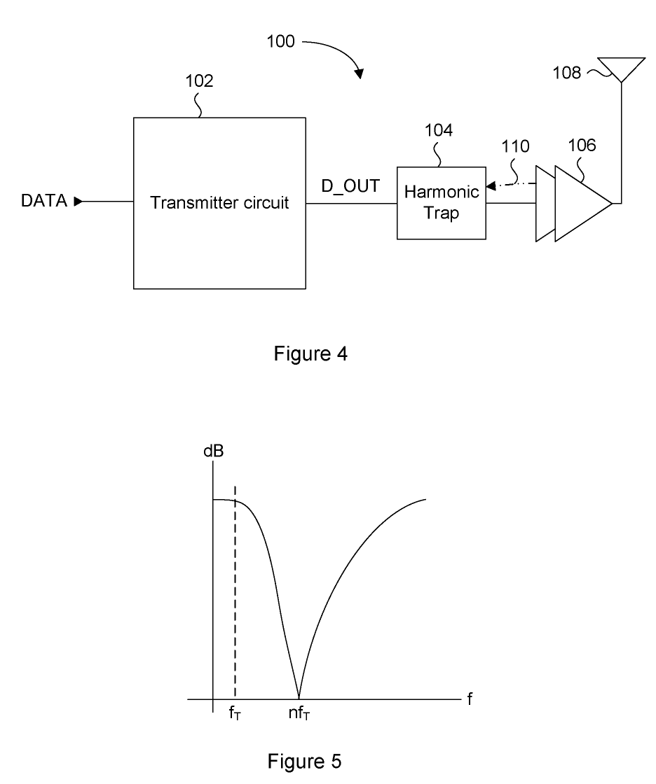

FIG. 4 is a schematic of the transmit path of a wireless system 100, according to an embodiment of the present invention. Wireless system 100 can include both a receive path and a transmit path, such as an RF transceiver, or just the transmit path. Wireless system 100 can be part of a mobile telephone, or any device with wireless communication capabilities. Those skilled in the art will understand that other circuits may be required to enable transmit path functionality, but are not shown to simplify the schematic as they are not relevant to the embodiments of the present invention. The presently illustrated transmit path includes a transmitter circuit 102, a harmonic trap 104, a power amplifier 106 and an antenna 108. The general function of the components of the transmit path are now discussed in further detail.

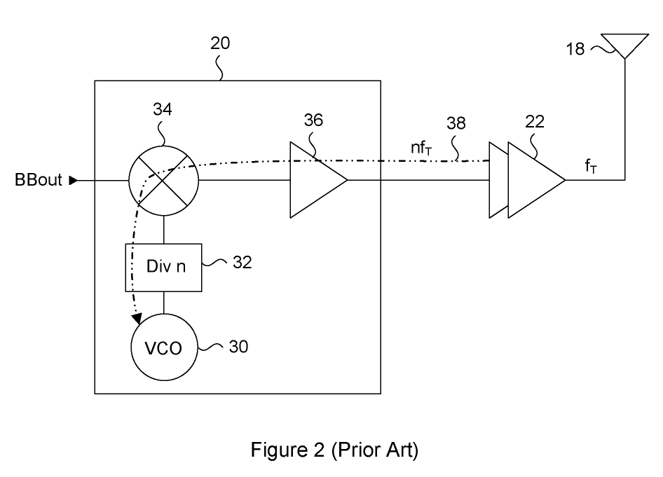

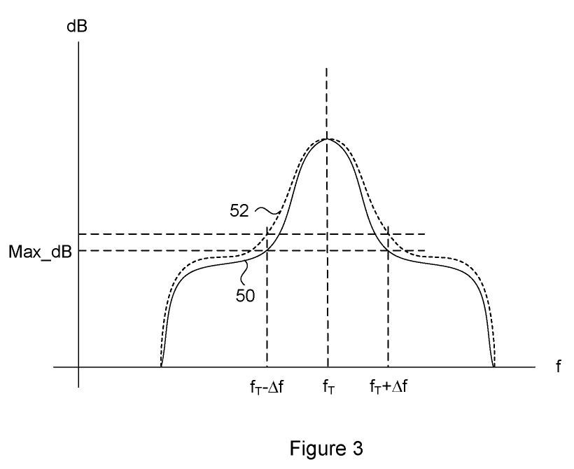

The transmitter circuit 102 receives a baseband signal data and converts it into a particular communication standard, such as GSM for example, at a desired transmit RF frequency f_{T}. The converted output signal is referred to as D_OUT. Transmitter circuit 102 can be a direct conversion transmitter core of an RF transceiver, where it will include components corresponding to those shown in the transmitter core 20 of FIG. 2. The harmonic trap 104 is connected in-line with the output signal D_OUT between the transmitter circuit 102 and the power amplifier 106. Harmonic trap 104 is a bi-directional circuit configured to pass D_OUT at f_{T}, but will inhibit a specific range of frequencies from passing through it. In the present context, inhibiting refers to blocking passage of signals or attenuating signals. More specifically, harmonic trap 104 behaves as a filter having a specific response for reducing the power of harmonics at the specific frequencies. The specificity of the harmonic trap 104 can be tailored based on the specific direct conversion architecture implementation of the transmitter circuit 102, and an understanding of the harmonics generated by the power amplifier 106.

The power amplifier 106 is a standard component used for amplifying the D_OUT signal provided by the transmitter circuit 102. This amplified signal is provided to the antenna 108 for wireless transmission. As previously mentioned, the power amplifier 106 has been identified as the source of generation of harmonics that can degrade performance of the transmitter circuit 102, should the harmonics leak back into the transmitter circuit 102. Since the most damaging harmonics generated by the power amplifier 106 are primarily at nf_{T}, where n is the division ratio of a divide-by-N circuit, similar to divide-by-N circuit 32,the configuration of the harmonic trap 104 for inhibiting harmonics will be set for nf_{T}. As shown in FIG. 4, power amplifier 106 will continue to generate nf_{T} harmonics, which flow towards the transmitter circuit 102 and VCO in path 110. However, due to harmonic trap 104, the damaging harmonics are inhibited from passing through to the transmitter circuit 102 or VCO.

Once the frequency of the harmonics generated by power amplifier 106 is known to be at nf_{T}, several passive or active circuit can be designed according to known techniques in the art for preventing the harmonics from passing back into the transmitter circuit 102. The attenuation vs frequency (f) response curve for the harmonic trap 104 is shown in FIG. 5. As shown in FIG. 5, the power at f_{T} is allowed to pass through the harmonic trap with low loss, but the power signal at nf_{T} drops to zero, or at least a neglible value insufficient for degrading performance of the transmitter circuit 102. Any passive or active circuit having the response characteristic of FIG. 5 will achieve the same result for the wireless system.

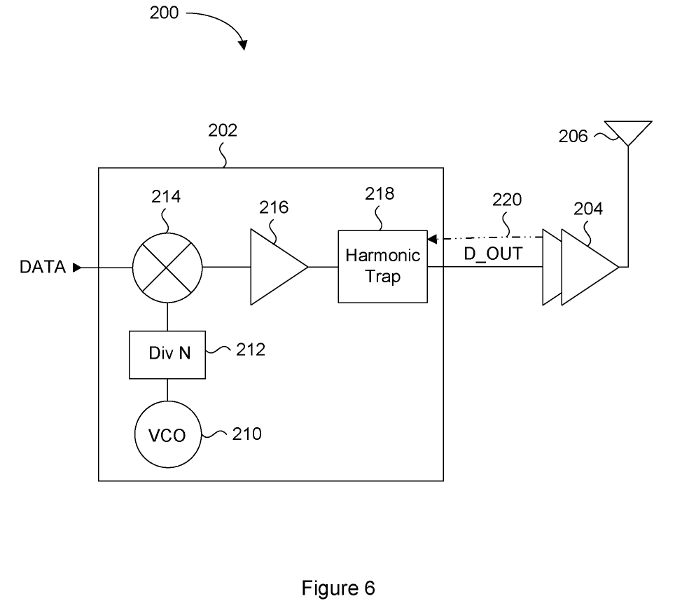

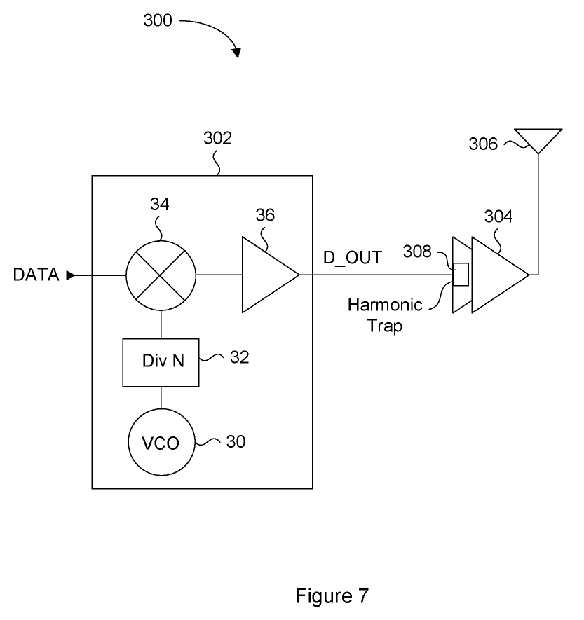

The embodiment of FIG. 4 illustrates one transmit path implementation in a wireless system 100. In most cases, the transmitter circuit 102, power amplifier 104 and antenna are assembled together and soldered onto a printed circuit board (PCB), where each is a discrete component or set of components. For example, the transmitter circuit 102 can be part of an RF transceiver chip, and the power amplifier 102 can be fabricated on its own chip. According to alternate embodiments shown in FIG. 6 and FIG. 7, the harmonic trap can be integrated with the transmitter circuit 102 or the power amplifier 104.

FIG. 6 is a schematic of the transmit path of a wireless system 200, according to an embodiment of the present invention. The presently illustrated transmit path includes a transmitter circuit 202, a power amplifier 204 and an antenna 206. The power amplifier 204 and the antenna 206 are the same as power amplifier 106 and antenna 108 of FIG. 4. Generally, the transmitter circuit 202 receives data from an upstream circuit, such as a baseband processor for example, and converts the data into the designated format with the transfer frequency f_{T}. The presently shown transmitter circuit 202 inhibits harmonics generated by the power amplifier 204 from degrading the performance thereof. The details of transmitter circuit 202 are now discussed in further detail.

Transmitter circuit 202 includes direct conversion circuitry, such as VCO 210, a divide-by-N circuit 212, a mixer 214 and a driver/amplifier 216. These components can be the same as the respective circuits shown in FIG. 2. According to the present embodiment, a harmonic trap 218 is integrated onto the same chip as the direct conversion circuitry to pass the output of driver/amplifier 216. The output signal D_OUT is provided from the output of harmonic trap 218 to power amplifier 204. Power amplifier 204 will continue to generate harmonics at nf_{T}, which will flow towards the transmitter circuit 202 in path 220. However, with the integrated harmonic trap 218 positioned in-line with the output signal between the direct conversion circuits, namely the driver/amplifier 216 and the power amplifier 204, the harmonics will be inhibited from reaching any of the direct conversion circuits. The integrated harmonic trap 218 can be implemented as either a passive or active circuit configured for inhibiting passage of signals at nf_{T}.

FIG. 7 is a schematic of the transmit path of a wireless system 300, according to another embodiment of the present invention. The presently illustrated transmit path includes a transmitter circuit 302, a power amplifier 304 and an antenna 306. The transmitter circuit 302 and the antenna 306 are the same as transmitter circuit 20 and antenna 18 of FIG. 2. The components of transmitter circuit 20 are numbered the same as those in FIG. 2. Instead of being integrated with the transmitter circuit as illustrated in FIG. 6, the harmonic trap 308 is integrated on the same chip as power amplifier 304, in-line with the output signal D_OUT between the transmitter circuit 302 and the power amplification circuits of power amplifier 304. Now, as the power amplification circuits generate harmonics at nf_{T}, they are attenuated by harmonic trap 308. Therefore the harmonics never leak back to the transmitter circuit 302, and in particular the VCO, with significant power.

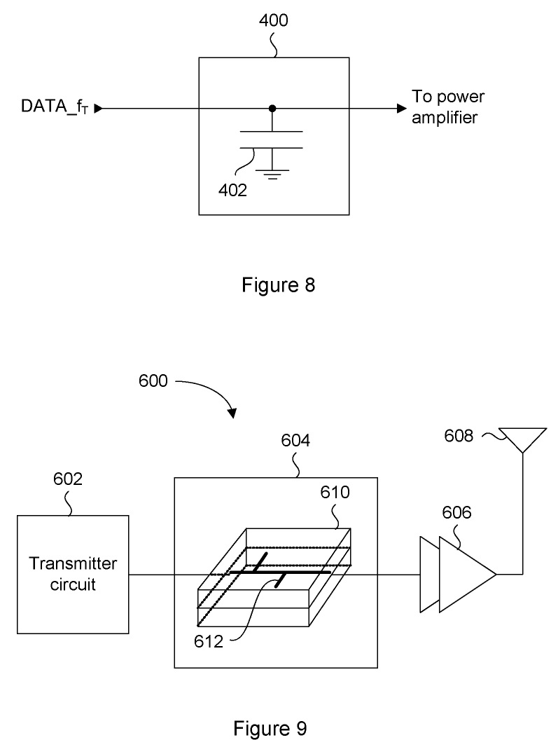

The previously discussed wireless system embodiments of FIGS. 4, 6 and 7 illustrate the possible system level implementations of the harmonic trap. The advantages of the embodiments of FIGS. 6 and 7 is the reduction in PCB area since a discrete harmonic trap is not required. FIGS. 8 to 9 now illustrate example embodiments of the harmonic trap which can be used in the wireless system embodiments of FIGS. 4, 6 and 7.

FIG. 8 illustrates a generic implementation example of a harmonic trap. The harmonic trap 400 consists of a capacitor 402 having one terminal connected to the signal line between the transmitter circuit and the power amplifier, or between direct conversion circuits and the power amplifier, or between the transmitter circuit and the power amplification circuitry of a power amplifier. In either case, the capacitor 402 is connected to the signal line carrying data at the transmit frequency f_{T} (DATA_f_{T}). The other terminal of capacitor 402 is connected to ground. Those skilled in the art will understand that parameters and parasitic reactive impairments of capacitor 402 can be adjusted to arrive at a desired response to pass a first range of specific frequencies, while a second range of frequencies greater than the first range are rejected or attenuated from passing through the circuit. More specifically for the embodiments of the present invention, the harmonic trap 400 inhibits harmonics at this second range of frequencies from returning to the transmitter circuit.

The harmonic trap embodiments of FIG. 8 is an example of a passive circuit which can be configured for inhibiting harmonics generated by the power amplifier from leaking back into the transmitter circuit. Those skilled in the art will understand that once the frequencies of the harmonics are known, then any passive circuit can be configured for inhibiting its passage. Active circuits and passive components arranged in known configurations can be used with equal effectiveness. While one capacitor 402 is shown, capacitor 402 can be implemented as a set of capacitors connected in parallel to each other. Furthermore, each capacitor can be selectively enabled or disabled change its response through simple switching means controlled by programmable registers or non-volatile programming means, such as fuses for example. Accordingly, the frequency response can be customized for the specific layout, configuration and devices of the system during a testing phase.

The transmit path embodiments of FIGS. 6 and 7 illustrate integration of the harmonic trap within other circuits, where the harmonic trap can be implemented as either passive or active components. In an alternate embodiment, the harmonic trap is integrated with the PCB itself. FIG. 9 is a schematic illustrating a wireless system 600 having a transmitter circuit 602, a harmonic trap 604, a power amplifier 606 and antenna 606. This embodiment does not require the use of any passive components, but uses distributed transmission lines in the PCB. In the wireless system, the transmitter circuit 602 and the power amplifier 606 are secured to a PCB 610. The PCB will have at least two layers within which conductor lines are routed for interconnecting different devices. The output of the transmitter circuit 602 and the input of power amplifier 606 will be connected via a transmission line. This conducting line can have distributed branch conductor lines 612 that can be designed to provide a response as shown in FIG. 5.

As shown in the embodiments of the present invention, a harmonic trap in series between a transmitter circuit and a power amplifier will be effective for inhibiting harmonics generated by the power amplifier from returning to the transmitter circuit. The harmonic trap can be implemented as a discrete device, or can be integrated within the transmitter circuit or the power amplifier to conserve PCB area.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A wireless device comprising:
a transmit circuit for providing an output signal at a transmit frequency;
a power amplifier for receiving the output signal and providing an amplified output signal, the power amplifier generating harmonics at a specific frequency; and,
a harmonic trap for passing the output signal having the transmit frequency and for inhibiting the harmonics from passing into the transmit circuit.

2. The wireless device of claim 1, wherein the specific frequency is an integer multiple of the transmit frequency.

3. The wireless device of claim 1, wherein the harmonic trap is a discrete device positioned in a path of the output signal between the transmit circuit and the power amplifier.

4. The wireless device of claim 1, wherein the harmonic trap is integrated with the transmit circuit.

5. The wireless device of claim 1, wherein the harmonic trap is integrated with the power amplifier.

6. The wireless device of claim 1, wherein the harmonic trap is a passive circuit.

7. The wireless device of claim 6, wherein the passive circuit includes a capacitor configured to have a frequency response effective for attenuating the harmonics at the specific frequency.

8. The wireless device of claim 6, wherein the passive circuit includes a set of capacitors selectively enabled in parallel with each other to have a frequency response effective for attenuating the harmonics at the specific frequency.

9. The wireless device of claim 1, wherein the harmonic trap is an active circuit.

10. The wireless device of claim 1, wherein the transmit circuit and the power amplifier are soldered to a printed circuit board, and the harmonic trap is integrated in the printed circuit board as distributed transmission lines.

11. A radio frequency transceiver for providing an output signal to a power amplifier, comprising:
a transmitter core for generating the output signal at a transmit frequency; and,
a harmonic trap for passing the output signal having the transmit frequency, and for inhibiting harmonics at a specific frequency from entering the transmitter core, the harmonics being generated by the power amplifier.

12. The radio frequency transceiver of claim 11, wherein the specific frequency is an integer multiple of the transmit frequency.

13. The radio frequency transceiver of claim 11, wherein the harmonic trap is a passive circuit.

14. The radio frequency transceiver of claim 11, wherein the harmonic trap is an active circuit.

15. A power amplifier for providing an amplified signal corresponding to an output signal received from a transmitter circuit, comprising:
amplification circuitry receiving the output signal for generating the amplified signal, the amplification circuitry generating harmonics at a specific frequency; and,
a harmonic trap for passing the output signal having a transmit frequency, and for inhibiting the harmonics from passing to the transmitter circuit.

16. The power amplifier of claim 15, wherein the specific frequency is an integer multiple of the transmit frequency.
